(19) United States
(12) Patent Application Publication
(10) Pub. No.: US 2011/0082861 A1
(43) Pub. Date: Apr. 7, 2011

(54) MEDIA ASSET USAGE BY GEOGRAPHIC REGION

(75) Inventors: Chad C. Gibson, Seattle, WA (US); Danyel A. Fisher, Seattle, WA (US)

(73) Assignee: MICROSOFT CORPORATION, Redmond, WA (US)

(21) Appl. No.: 12/571,636

(22) Filed: Oct. 1, 2009

(51) Int. Cl. G06F 17/00

(52) U.S. Cl. 707/737; 707/E17.009; 707/803

(57) ABSTRACT

Media asset usage by geographic region is described. In embodiments, media asset interaction data is received from user devices, where the media asset interaction data corresponds to a media asset and identifies the media asset when recently played at any of the user devices. Geographic location data that corresponds to each of the user devices is also received. The geographic location data and the media asset interaction data that corresponds to the media asset are aggregated, and a geographic density map is generated as a visual indication of aggregated locations and interactions with the media asset in a geographic region.

### BACKGROUND

Media asset usage varies from city to city, and similarly can vary from one zip code, state, or geographic region to another. For example, the people living in a city on the East coast may listen to different music by different artists, and watch different types of movies, than the people living in a city on the West coast. A person that travels, visits, or moves from one geographic location to another may have an interest in finding out what music and movies are popular or current at a new location. However, current techniques are limited for a person to ascertain and understand media asset usage in a current or new location, or other geographic region.

### SUMMARY

This summary is provided to introduce simplified concepts of media asset usage by geographic region. The simplified concepts are further described below in the Detailed Description. This summary is not intended to identify essential features of the claimed subject matter, nor is it intended for use in determining the scope of the claimed subject matter.

Media asset usage by geographic region is described. In embodiments, media asset interaction data is received from user devices, where the media asset interaction data corresponds to a media asset and identifies the media asset when recently played at any of the user devices. A media asset can include a digital music file of a song, a television program, a movie, an on-demand media asset, or any other type of media asset. Geographic location data that corresponds to each of the user devices is also received. The geographic location data and the media asset interaction data that corresponds to the media asset are aggregated, and a geographic density map is generated as a visual indication of aggregated locations and interactions with the media asset in a geographic region. A geographic region can include any one or combination of a city, a state, a zip code, or a country.

In other embodiments, the media asset interaction data corresponds to media assets that are associated with a performer or a genre, and the media asset interaction data identifies the media assets when recently played at any of the user devices. A performer may be an artist, a singer, an actor or actress, or any other performer. The geographic location data and the media asset interaction data that corresponds to the plurality of media assets are aggregated. The geographic density map is then generated as the visual indication of the aggregated locations and interactions with the media assets that are associated with the performer or the genre in the geographic region.

In other embodiments, a request can be received from a user device for the geographic density map that is associated with a media asset, and the geographic density map can be communicated for display at the user device. The request for the geographic density map can be received with aggregation criteria for current media asset interactions with the media asset. The geographic location data and the media asset interaction data can then be aggregated according to the aggregation criteria, and the geographic density map can be generated according to the aggregation criteria for the media asset interactions with the media asset in the geographic region. Additionally, the request for the geographic density map can be received with additional aggregation criteria that includes any one of a number of days, a number of weeks, or a number of months of the media asset interactions with the media asset at the user devices.

### BRIEF DESCRIPTION OF THE DRAWINGS

Embodiments of media asset usage by geographic region are described with reference to the following drawings. The same numbers are used throughout the drawings to reference like features and components:

FIG. 1 illustrates an example system in which embodiments of media asset usage by geographic region can be implemented.

FIG. 2 illustrates examples of geographic density maps displayed at a user device.

FIG. 3 illustrates example method(s) for media asset usage by geographic region in accordance with one or more embodiments.

FIG. 4 illustrates various components of an example device that can implement embodiments of media asset usage by geographic region.

### DETAILED DESCRIPTION

Embodiments of media asset usage by geographic region provide a geographic density map that can display a popularity and/or trends of distinct media assets, songs, song types, movies, music artists, performers, and the like throughout a geographic region. A geographic region shown in a geographic density map can be any one of a city, a state, a zip code, a country, or any other geographic location or region. A geographic density map provides a visual indication of media asset usage trends for a given geographic region, and a user can view the relative popularity of media content and media assets specific to a geographic region or area. In one example, a local music artist can utilize and/or link to a geographic density map to get a visual indication and idea as to whether users of devices are playing the artist's music, and where in the United States is the artist becoming better known. This provides the local music artist with more granular and accurate media usage data than simply samplings from a limited number of markets, or from what radio stations may be promoting.

While features and concepts of the described systems and methods for media asset usage by geographic region can be implemented in any number of different environments, systems, and/or various configurations, embodiments of media asset usage by geographic region are described in the context of the following example systems and environments.

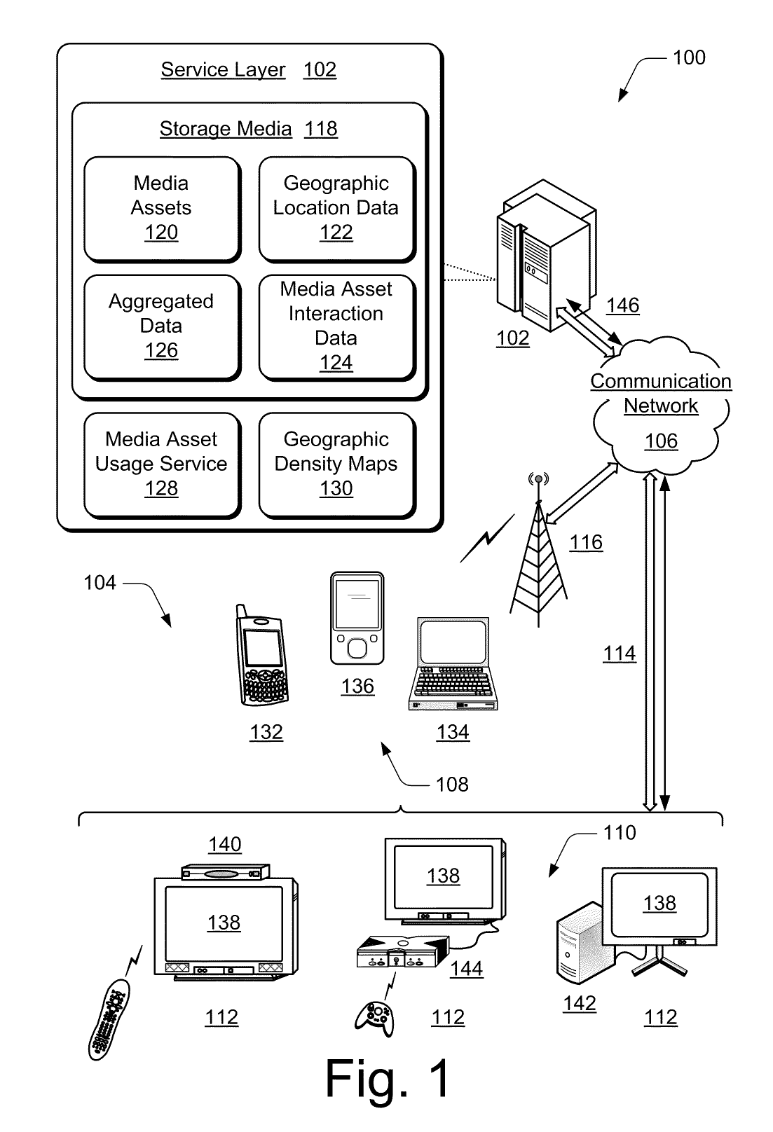

FIG. 1 illustrates an example system 100 in which various embodiments of media asset usage by geographic region can be implemented. In this example, system 100 includes a service layer 102 that can be configured to communicate or otherwise provide media assets and data to any number of various devices 104 via a communication network 106. The various devices 104 are also referred to as user devices and/or client devices. The various devices 104 can include wireless devices 108 as well as other client devices 110 (e.g., wired and/or wireless devices) that are implemented as components in various client systems 112 in a media asset distribution system.

The communication network 106 can be implemented to include a broadcast network, an IP-based network 114, and/or a wireless network 116 that facilitates media asset distribution and data communication between the service layer 102 and any number of the various devices. The communication network 106 can also be implemented as part of a media asset distribution system using any type of network topology and/or communication protocol, and can be represented or otherwise implemented as a combination of two or more networks.

Service layer 102 can include one or more media content servers that are implemented to communicate, or otherwise distribute, the media assets 120 and/or other data to any number of the various user devices. In this example system 100, service layer 102 includes storage media 118 to store or otherwise maintain various data and media assets, such as media assets 120, geographic location data 122, media asset interaction data 124, and aggregated data 126 that includes locations and user interactions with media assets in geographic regions. The storage media 118 can be implemented as any type of memory, random access memory (RAM), a nonvolatile memory such as flash memory, read only memory (ROM), and/or other suitable electronic data storage.

The media assets 120 can include any type of audio, video, and/or image data received from any type of media content or data source. As described throughout, media assets can include music (e.g., digital music files of songs), television programming, movies, on-demand media assets, interactive games, network-based applications, and any other audio, video, and/or image data (e.g., to include program guide data, user interface data, advertising content, closed captions data, content metadata, search results and/or recommendations, etc.).

The media asset interaction data 124 corresponds to a media asset and identifies the media asset when recently played at any of the various devices 104. The media asset interaction data 124 correlates to a media asset, or media assets, that have been selected by a user and/or user interactions with the selected media assets via any of the various user devices. A user device can communicate the media asset interaction data 124 to the service layer 102 when the media asset is recently played or rendered at the user device. Alternatively or in addition, the service layer 102 can poll the various devices to request the media asset interaction data.

In various embodiments, the media asset interaction data 124 can correspond to a single media asset that is recently played at one or more of the various devices 104. Alternatively or in addition, the media asset interaction data 124 can correspond to a collection of media assets that are associated with a performer, such as an artist, a singer, an actor or actress, or any other performer. Alternatively or in addition, the media asset interaction data 124 can correspond to a genre of media assets, where a genre describes the media assets, such as video content, as being an advertisement, a movie, a comedy show, a sporting event, a news program, a sitcom, a talk show, an action/adventure program, or as any number of other category descriptions.

The geographic location data 122 corresponds to each of the user devices and identifies where a user device is located. The geographic location data 122 can be collected any one of before, during, or after a media asset is played or rendered at a user device. The geographic location data 122 can be communicated to the service layer 102 by the various devices 104 and/or requested by the service layer 102. The geographic location data 122 can also be determined automatically, such as by a GPS system integrated with a user device that can determine a real time location of the device. It should be noted that there are a variety of ways in which the location of a user device can be determined.

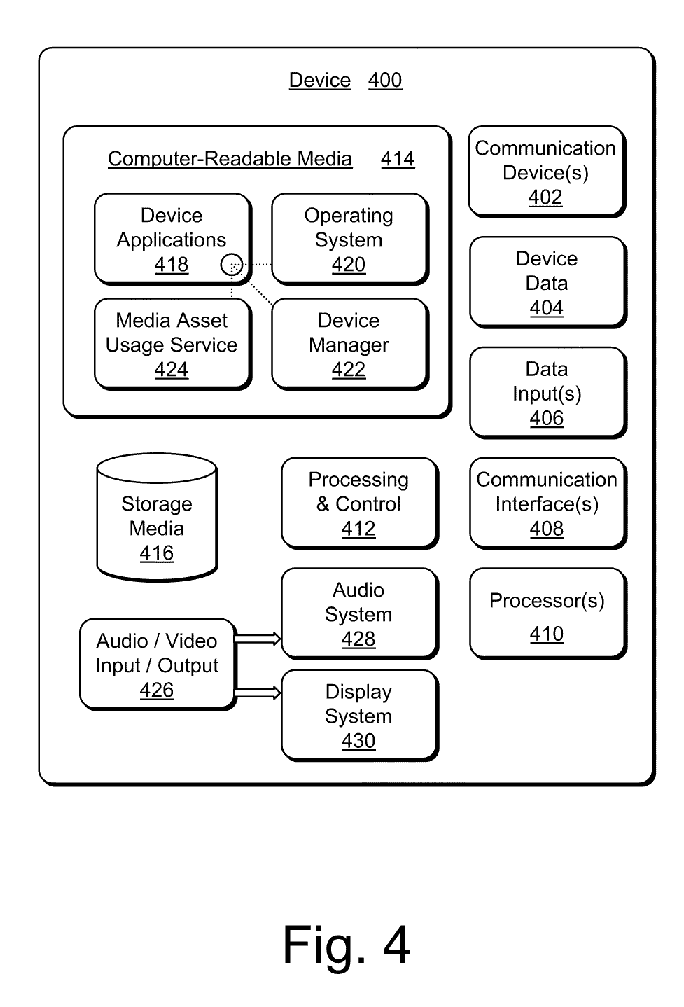

The service layer 102 includes a media asset usage service 128 that can be implemented as computer-executable instructions and executed by processors to implement the various embodiments and/or features described herein. In addition, the service layer 102 can be implemented with any number and combination of differing components as further described with reference to the example device shown in FIG. 4. The media asset usage service 128, as well as other functionality described to implement embodiments of media asset usage by geographic region, can also be provided as a service apart from the service layer 102 (e.g., on a separate server or by a third party service).

The media asset usage service 128 can be implemented to aggregate the geographic location data 122 and the media asset interaction data 124 that corresponds to a media asset. The media asset interaction data 124 for media asset usage can be accumulated and collected as a feed of geographic consumption points. The media asset usage service 128 can then generate a geographic density map 130 as a visual indication of aggregated locations and interactions with the media asset in a geographic region. A geographic region shown in a geographic density map 130 can be any one of a city, a state, a zip code, a country, or any other geographic location or region. A geographic density map 130 provides a visual indication of media asset usage trends for a given geographic region, and a user can view and ascertain the relative popularity of media content and media assets specific to a geographic region or area.

In other embodiments, the media asset usage service 128 can aggregate the geographic location data 122 and the media asset interaction data 124 that corresponds to a collection of media assets that are associated with a performer, or with a genre that describes the media assets. The media asset usage service can then generate a geographic density map as the visual indication of the aggregated locations and interactions with the media assets that are associated with the performer and/or a genre in a geographic region.

The media asset usage service 128 at the service layer 102 can receive a request for a geographic density map 130 from any of the various devices 104, and the request can include aggregation criteria for current media asset interactions with a media asset, or media assets. The aggregation criteria can include the current interactions with a media asset, or any one of a number of days, a number of weeks, or a number of months of the media asset interactions with the media asset. The media asset usage service 128 can then aggregate the geographic location data 122 and the media asset interaction data 124 according to the aggregation criteria, and generate the geographic density map 130 according to the aggregation criteria for the media asset interactions with the media asset in a geographic region.

In an implementation, geographic feeds can be generated based upon a query for an aggregate data set specific to a media asset, such as defined by the aggregation criteria. The feed of geographic data can be scaled based on a current viewing window for a user experience when viewing a geographic density map 130. The geographic data can be scaled over a specific duration of time or number of days, based on a popularity scaling, such as repeat plays of a media asset at a user device, as well as based on random sampling across a specific media asset. The amplitude of specific geographic region points can then be visualized on a geographic density map 130 that can display popularity and/or trends of distinct media assets, songs, song types, movies, music artists, performers, and the like. A geographic density map 130 can be generated by the media asset usage service 128 and then downloaded or otherwise communicated to any of the various user devices.

In this example 100, the wireless devices 108 can include any type of device implemented to receive and/or communicate wireless data, such as any one or combination of a mobile phone 132 (e.g., cellular, VoIP, WiFi, etc.), a portable computer device 134, a media device 136 (e.g., a personal media player, portable media player, etc.), and/or any other wireless device that can receive media assets in any form of audio, video, and/or image data. Each of the client systems 112 include a respective client device and display device 138 that together render or playback any form of audio, video, and/or image media content and media assets.

A display device 138 can be implemented as any type of a television, high definition television (HDTV), LCD, or similar display system. A client device in a client system 112 can be implemented as any one or combination of a television client device 140 (e.g., a television set-top box, a digital video recorder (DVR), etc.), a computer device 142, a gaming system 144, an appliance device, an electronic device, and/or as any other type of client device or user device that may be implemented to receive media assets in any form of audio, video, and/or image data in a media asset distribution system.

Any of the various devices 104 can be implemented with one or more processors, communication components, memory components, signal processing and control circuits, and a media asset rendering system. Further, any of the wireless devices 108 and/or other client devices 110 can be implemented with any number and combination of differing components as further described with reference to the example device shown in FIG. 4. A user device may also be associated with a user (i.e., a person) and/or an entity that operates the device such that a user device describes logical devices that include users, software, and/or a combination of devices.

Any of the wireless devices 108 and/or other client devices 110 can communicate with service layer 102 via a two-way data communication link 146 of the communication network 106. It is contemplated that any one or more of the arrowed communication link 146, IP-based network 114, and wireless network 116, along with communication network 106, facilitate two-way data communication, such as from a user device to the service layer 102 and vice-versa.

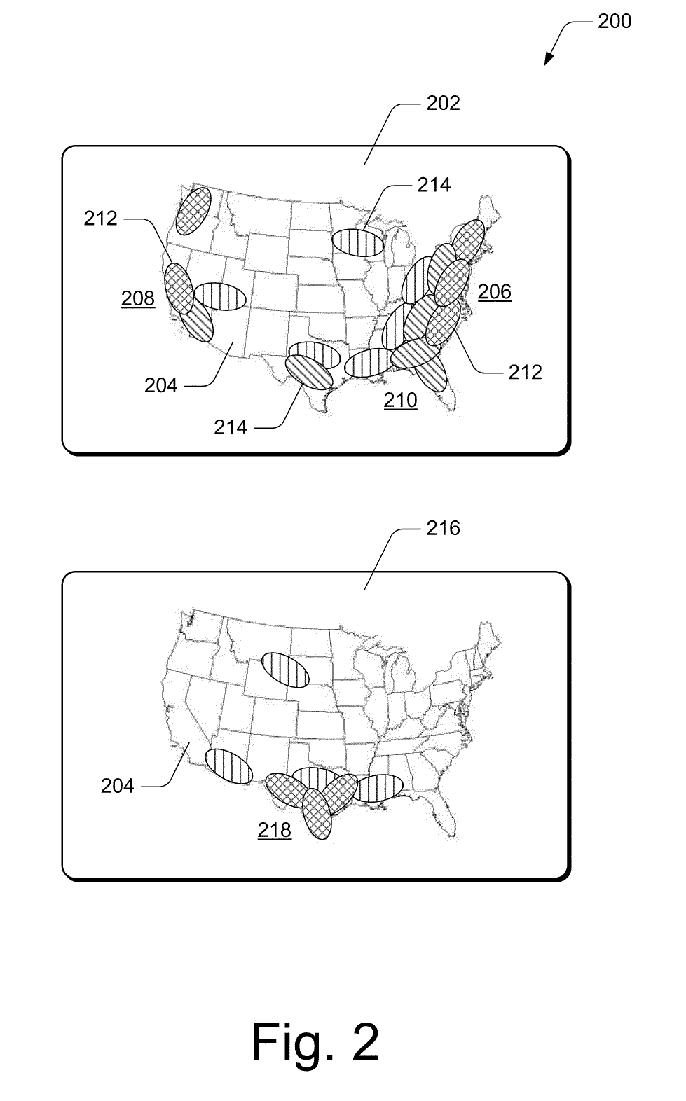

FIG. 2 illustrates examples 200 of geographic density maps displayed on a display device at a user device, such as at any of the various devices shown in FIG. 1. A geographic density map 202 is a visual indication of aggregated locations and interactions at user devices (e.g., by users) with a collection of media assets that are associated with a well-known music artist throughout a geographic region 204, such as the United States in this example. The geographic density map 202 illustrates that the particular music artist is popular on the East coast 206, in larger metropolitan areas on the West coast 208, and is gaining popularity throughout a Southern region 210 of the United States. A greater density of the aggregated data can represent where the music artist is most popular throughout the geographic region 204.

In this example, the varying density representations are shown as symbols having a greater pattern fill at 212 for example, or less of a pattern fill at 214 for example. It should be noted that the particular symbols shown in this example to represent the varying density representations are merely illustrative for discussion purposes. When embodiments of media asset usage by geographic region are implemented, a representation of media asset interaction density shown on a geographic density map can be displayed in any form, pattern, image, graphic, icon, color, size, shape or other visual indication.

A geographic density map 216 is a visual indication of aggregated locations and interactions at user devices (e.g., by users) with media assets that are associated with a local music artist throughout the geographic region 204. The geographic density map 216 illustrates that the particular music artist has localized popularity in Texas at 218 and is beginning to grow in popularity in other scattered geographic regions of the United States. The local artist can utilize and/or link to the geographic density map 216 to get a visual indication and idea as to whether users of devices are playing the artist's music, and where in the United States is the artist becoming better known. This provides the local music artist with more granular and accurate media usage data than simply samplings from a limited number of markets, or from what radio stations may be promoting.

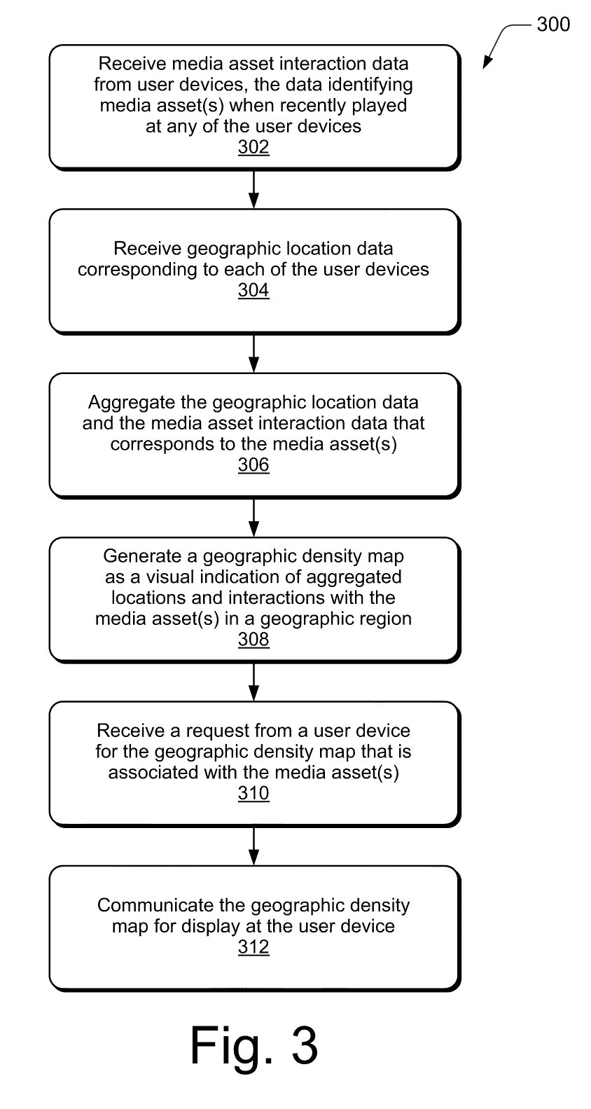

Example method 300 is described with reference to FIG. 3 in accordance with one or more embodiments of media asset usage by geographic region. Generally, any of the functions, methods, procedures, components, and modules described herein can be implemented using hardware, software, firmware, fixed logic circuitry, manual processing, or any combination thereof. A software implementation represents program code that performs specified tasks when executed by a computer processor. The example methods may be described in the general context of computer-executable instructions, which can include software, applications, routines, programs, objects, components, data structures, procedures, modules, functions, and the like. The methods may also be practiced in a distributed computing environment by processing devices that are linked through a communication network. In a distributed computing environment, computer-executable instructions may be located in both local and remote computer storage media and/or devices. Further, the features described herein are platform-independent and can be implemented on a variety of computing platforms having a variety of processors.

FIG. 3 illustrates example method(s) 300 of media asset usage by geographic region. The order in which the method is described is not intended to be construed as a limitation, and any number of the described method blocks can be combined in any order to implement the method, or an alternate method.

At block 302, media asset interaction data is received from user devices. For example, the service layer 102 receives the media asset interaction data 124 from the various devices 104. The media asset interaction data 124 corresponds to a media asset 120 and identifies the media asset when recently played at any of the user devices. A media asset played or rendered at a user device may be a digital music file of a song, a television program, a movie, an on-demand media asset, or any other type of media asset. Additionally, the media asset interaction data can correspond to a collection of media assets 120 that are associated with a performer or a genre, and the media asset interaction data 124 identifies the media assets when recently played at any of the user devices. In this example, a performer may be an artist, a singer, an actor or actress, or any other performer.

At block 304, geographic location data corresponding to each of the user devices is received. For example, the service layer 102 receives the geographic location data 122 from the various devices 104. The geographic location data 122 identifies where a user device is located, and can be collected any one of before, during, or after a media asset is played or rendered at a user device.

At block 306, the geographic location data and the media asset interaction data that corresponds to the media asset, or media assets, is aggregated. For example, the media asset usage service 128 aggregates the geographic location data 122 and the media asset interaction data 124 that corresponds to a media asset, or media assets.

At block 308, a geographic density map is generated as a visual indication of aggregated locations and interactions with the media asset in a geographic region. For example, the media asset usage service 128 generates a geographic density map 130 as a visual indication of aggregated locations and interactions with the media asset, or media assets, in a geographic region. A geographic region shown in a geographic density map can be any one of a city, a state, a zip code, a country, or any other geographic location or region. Alternatively or in addition, the media asset usage service 128 generates the geographic density map 202 as the visual indication of the aggregated locations and interactions with media assets that are associated with a performer or the genre in the geographic region.

At block 310, a request is received from a user device for the geographic density map that is associated with the media asset. For example, the media asset usage service 128 at the service layer 102 can receive a request for a geographic density map 130 from any of the various devices 104, and the request can include aggregation criteria for current media asset interactions with a media asset, or media assets. The aggregation criteria can include the current interactions with a media asset, or any one of a number of days, a number of weeks, or a number of months of the media asset interactions with the media assets. The media asset usage service 128 can then aggregate (e.g., at block 306) the geographic location data 122 and the media asset interaction data 124 according to the aggregation criteria, and generate (e.g., at block 308) the geographic density map 130 according to the aggregation criteria for the media asset interactions with the media assets in a geographic region.

At block 312, the geographic density map is communicated for display at the user device. For example, the geographic density map 202 is generated by the media asset usage service 128 and then downloaded or otherwise communicated to any of the various user devices.

FIG. 4 illustrates various components of an example device 400 that can be implemented as any type of device and/or service layer as described with reference to FIGS. 1 and 2 to implement embodiments of media asset usage by geographic region. In embodiments, device 400 can be implemented as any one or combination of a wired and/or wireless device, as any form of television client device (e.g., television set-top box, digital video recorder (DVR), etc.), consumer device, computer device, portable computer device, user device, communication device, video processing and/or rendering device, appliance device, gaming device, electronic device, and/or as any other type of device. Device 400 may also be associated with a user (i.e., a person) and/or an entity that operates the device such that a device describes logical devices that include users, software, firmware, and/or a combination of devices.

Device 400 includes communication devices 402 that enable wired and/or wireless communication of device data 404 (e.g., received data, data that is being received, data scheduled for broadcast, data packets of the data, etc.). The device data 404 or other device content can include configuration settings of the device, media content stored on the device, and/or information associated with a user of the device. Media content stored on device 400 can include any type of audio, video, and/or image data. Device 400 includes one or more data inputs 406 via which any type of data, media content, and/or inputs can be received, such as user-selectable inputs, messages, music, television media content, recorded video content, and any other type of audio, video, and/or image data received from any content and/or data source.

Device 400 also includes communication interfaces 408 that can be implemented as any one or more of a serial and/or parallel interface, a wireless interface, any type of network interface, a modem, and as any other type of communication interface. The communication interfaces 408 provide a connection and/or communication links between device 400 and a communication network by which other electronic, computing, and communication devices communicate data with device 400.

Device 400 includes one or more processors 410 (e.g., any of microprocessors, controllers, and the like) which process various computer-executable instructions to control the operation of device 400 and to implement embodiments of media asset usage by geographic region. Alternatively or in addition, device 400 can be implemented with any one or combination of hardware, firmware, or fixed logic circuitry that is implemented in connection with processing and control circuits which are generally identified at 412. Although not shown, device 400 can include a system bus or data transfer system that couples the various components within the device. A system bus can include any one or combination of different bus structures, such as a memory bus or memory controller, a peripheral bus, a universal serial bus, and/or a processor or local bus that utilizes any of a variety of bus architectures.

Device 400 also includes computer-readable media 414, such as one or more memory components, examples of which include random access memory (RAM), non-volatile memory (e.g., any one or more of a read-only memory (ROM), flash memory, EPROM, EEPROM, etc.), and a disk storage device. A disk storage device may be implemented as any type of magnetic or optical storage device, such as a hard disk drive, a recordable and/or rewriteable compact disc (CD), any type of a digital versatile disc (DVD), and the like. Device 400 can also include a mass storage media device 416.

Computer-readable media 414 provides data storage mechanisms to store the device data 404, as well as various device applications 418 and any other types of information and/or data related to operational aspects of device 400. For example, an operating system 420 can be maintained as a computer application with the computer-readable media 414 and executed on processors 410. The device applications 418 can include a device manager 422 (e.g., a control application, software application, signal processing and control module, code that is native to a particular device, a hardware abstraction layer for a particular device, etc.). The device applications 418 also include any system components or modules to implement embodiments of media asset usage by geographic region. In this example, the device applications 418 include a media asset usage service 424 that is shown as a software module and/or computer application. Alternatively or in addition, the media asset usage service 424 can be implemented as hardware, software, firmware, or any combination thereof.

Device 400 also includes an audio and/or video input-output system 426 that provides audio data to an audio system 428 and/or provides video data to a display system 430. The audio system 428 and/or the display system 430 can include any devices that process, display, and/or otherwise render audio, video, and image data. Video signals and audio signals can be communicated from device 400 to an audio device and/or to a display device via an RF (radio frequency) link, S-video link, composite video link, component video link, DVI (digital video interface), analog audio connection, or other similar communication link. In an embodiment, the audio system 428 and/or the display system 430 are implemented as external components to device 400. Alternatively, the audio system 428 and/or the display system 430 are implemented as integrated components of example device 400.

Although embodiments of media asset usage by geographic region have been described in language specific to features and/or methods, it is to be understood that the subject of the appended claims is not necessarily limited to the specific features or methods described. Rather, the specific features and methods are disclosed as example implementations of media asset usage by geographic region.

1. A computer-implemented method, comprising:
receiving media asset interaction data from user devices, the media asset interaction data corresponding to a media asset and identifying the media asset when recently played at any of the user devices;
receiving geographic location data corresponding to each of the user devices;
aggregating the geographic location data and the media asset interaction data that corresponds to the media asset; and
generating a geographic density map as a visual indication of aggregated locations and interactions with the media asset in a geographic region.

2. A computer-implemented method as recited in claim 1, wherein the media asset interaction data corresponds to a plurality of media assets that are associated with a performer, and the media asset interaction data identifies the plurality of media assets when recently played at any of the user devices;
the computer-implemented method further comprising:
aggregating the geographic location data and the media asset interaction data that corresponds to the plurality of media assets; and
generating the geographic density map as the visual indication of the aggregated locations and interactions with the plurality of media assets that are associated with the performer in the geographic region.

3. A computer-implemented method as recited in claim 2, wherein the performer includes at least one of an artist, a singer, or an actor.

4. A computer-implemented method as recited in claim 1, wherein the media asset interaction data corresponds to a plurality of media assets that are associated with a genre, and the media asset interaction data identifies the plurality of media assets when recently played at any of the user devices;
the computer-implemented method further comprising:
aggregating the geographic location data and the media asset interaction data that corresponds to the plurality of media assets; and
generating the geographic density map as the visual indication of the aggregated locations and interactions with the plurality of media assets that are associated with the genre in the geographic region.

5. A computer-implemented method as recited in claim 1, wherein the media asset is at least one of a digital music file of a song, a television program, or an on-demand media asset.

6. A computer-implemented method as recited in claim 1, wherein the geographic region shown in the geographic density map is at least one of a city, a state, a zip code, or a country.

7. A computer-implemented method as recited in claim 1, further comprising:
receiving a request from a user device for the geographic density map that is associated with the media asset; and
communicating the geographic density map for display at the user device.

8. A computer-implemented method as recited in claim 7, wherein the request for the geographic density map is received with aggregation criteria for current media asset interactions with the media asset, the computer-implemented method further comprising:
aggregating the geographic location data and the media asset interaction data according to the aggregation criteria; and
generating the geographic density map according to the aggregation criteria for the media asset interactions with the media asset in the geographic region.

9. A computer-implemented method as recited in claim 8, wherein the request for the geographic density map is received with additional aggregation criteria that includes at least one of a number of days, a number of weeks, or a number of months of the media asset interactions with the media asset.

10. A system, comprising:
storage media configured to maintain media asset interaction data and geographic location data, the media asset interaction data corresponding to a media asset and identifying the media asset when recently played at user devices, the geographic location data corresponding to each of the user devices;
at least a memory and a processor that implement a media asset usage service configured to:
aggregate the geographic location data and the media asset interaction data that corresponds to the media asset; and
generate a geographic density map as a visual indication of aggregated locations and interactions with the media asset in a geographic region.

11. A system as recited in claim 10, wherein:
the media asset interaction data corresponds to a plurality of media assets that are associated with a performer, and the media asset interaction data identifies the plurality of media assets when recently played at any of the user devices; and wherein
the media asset usage service is further configured to:
aggregate the geographic location data and the media asset interaction data that corresponds to the plurality of media assets; and
generate the geographic density map as the visual indication of the aggregated locations and interactions with the plurality of media assets that are associated with the performer in the geographic region.

12. A system as recited in claim 11, wherein the performer includes at least one of an artist, a singer, or an actor.

13. A system as recited in claim 10, wherein:
the media asset interaction data corresponds to a plurality of media assets that are associated with a genre, and the media asset interaction data identifies the plurality of media assets when recently played at any of the user devices; and wherein
the media asset usage service is further configured to:
aggregate the geographic location data and the media asset interaction data that corresponds to the plurality of media assets; and
generate the geographic density map as the visual indication of the aggregated locations and interactions with the plurality of media assets that are associated with the genre in the geographic region.

14. A system as recited in claim 10, wherein the media asset is at least one of a digital music file of a song, a television program, or an on-demand media asset.

15. A system as recited in claim 10, wherein the geographic region shown in the geographic density map is at least one of a city, a state, a zip code, or a country.

16. A system as recited in claim 10, wherein the media asset usage service is further configured to:
receive a request for the geographic density map with aggregation criteria for current media asset interactions with the media asset:
aggregate the geographic location data and the media asset interaction data according to the aggregation criteria; and
generate the geographic density map according to the aggregation criteria for the media asset interactions with the media asset in the geographic region.

17. A system as recited in claim 16, wherein the request for the geographic density map is received with additional aggregation criteria that includes at least one of a number of days, a number of weeks, or a number of months of the media asset interactions with the media asset.

18. Computer-readable storage media having stored thereon computer-executable instructions that, when executed by a server device, initiate the server device to:
receive media asset interaction data from user devices, the media asset interaction data corresponding to a media asset and identifying the media asset when recently played at any of the user devices;
receive geographic location data corresponding to each of the user devices;
aggregate the geographic location data and the media asset interaction data that corresponds to the media asset; and
generate a geographic density map as a visual indication of aggregated locations and interactions with the media asset in a geographic region.

19. Computer-readable storage media as recited in claim 18, wherein the computer-executable instructions, when executed, further initiate the server device to:
receive a request from a user device for the geographic density map that is associated with the media asset; and
communicate the geographic density map for display at the user device.

20. Computer-readable storage media as recited in claim 19, wherein the computer-executable instructions, when executed, further initiate the server device to:
receive the request for the geographic density map with aggregation criteria for the media asset interactions with the media asset, the aggregation criteria including at least one of a number of days, a number of weeks, or a number of months of the media asset interactions with the media asset;
aggregate the geographic location data and the media asset interaction data according to the aggregation criteria; and
generate the geographic density map according to the aggregation criteria for the media asset interactions with the media asset in the geographic region.
